(19) United States
(12) Patent Application Publication
(10) Pub. No.: US 2024/0019295 A1
(43) Pub. Date: Jan. 18, 2024

(54) ULTRASONIC MEASUREMENT APPARATUS, METHOD, AND RECORDING MEDIUM

(71) Applicant: ADVANTEST CORPORATION, Tokyo (JP)

(72) Inventor: Taiichiro IDA, Gunma (JP)

(73) Assignee: ADVANTEST CORPORATION, Tokyo (JP)

(21) Appl. No.: 18/133,109

(22) Filed: Apr. 11, 2023

(30) Foreign Application Priority Data
Jul. 15, 2022 (JP) 2022-114129

(51) Int. Cl. G01H 9/00; G10K 11/30

(52) U.S. Cl. CPC G01H 9/004; G10K 11/30

(57) ABSTRACT

An ultrasonic measurement apparatus includes a lens, an ultrasonic measuring section, an ultrasonic determining section, and a lens moving section. The lens receives an ultrasonic wave output from a measuring target. The ultrasonic measuring section measures the ultrasonic wave received by the lens in relation to time. The ultrasonic determining section determines whether or not the ultrasonic wave is included in a result of measurement by the ultrasonic measuring section at an elapsed time point when the time required for the ultrasonic wave to travel a focal distance of the lens has elapsed after the ultrasonic wave is output from the measuring target. The lens moving section moves the lens such that it is determined that the ultrasonic wave is included in the result of measurement by the ultrasonic measuring section.

### BACKGROUND OF THE INVENTION

### Field of the Invention

The present invention relates to ultrasonic measuring.

### Description of the Related Art

There have conventionally been known techniques for measuring a reflected wave generated by applying an ultrasonic wave to a measuring target (see Japanese Patent Application Publication Nos. 2013-055984 and H07-229705, for example) and techniques for measuring an optoacoustic wave generated by applying pulsed light to a measuring target (see Japanese Patent Application Publication No. 2018-008040, for example).

There have also been known techniques for measuring an optoacoustic wave with an acoustic lens to indicate the position of the focal point of the acoustic lens (see Japanese Patent Application Publication No. 2020-156737, for example).

### SUMMARY OF THE INVENTION

However, even when the position of the focal point of the acoustic lens may be indicated, the user him/herself has to manually focus the acoustic lens on the measuring target, which requires a lot of work.

Automatic focusing of an acoustic lens is hence an object of the present invention.

According to the present invention, an ultrasonic measurement apparatus, includes: a lens arranged to receive an ultrasonic wave output from a measuring target; an ultrasonic measuring section arranged to measure the ultrasonic wave received by the lens in relation to time; an ultrasonic determining section arranged to determine whether or not the ultrasonic wave is included in a result of measurement by the ultrasonic measuring section at an elapsed time point when the time required for the ultrasonic wave to travel a focal distance of the lens has elapsed after the ultrasonic wave is output from the measuring target; and a lens moving section arranged to move the lens such that it is determined that the ultrasonic wave is included in the result of measurement by the ultrasonic measuring section.

According to the thus constructed ultrasonic measurement apparatus, a lens receives an ultrasonic wave output from a measuring target. An ultrasonic measuring section measures the ultrasonic wave received by the lens in relation to time. An ultrasonic determining section determines whether or not the ultrasonic wave is included in a result of measurement by the ultrasonic measuring section at an elapsed time point when the time required for the ultrasonic wave to travel a focal distance of the lens has elapsed after the ultrasonic wave is output from the measuring target. A lens moving section moves the lens such that it is determined that the ultrasonic wave is included in the result of measurement by the ultrasonic measuring section.

According to the present invention, the ultrasonic measurement apparatus may further include an ultrasonic pulse output section arranged to output an ultrasonic pulse, wherein the ultrasonic wave is a reflection of the ultrasonic pulse by the measuring target.

According to the ultrasonic measurement apparatus of the present invention, the elapsed time point may be taken within a predetermined range of a time point obtained by adding twice the focal distance divided by the speed of sound to the time point when the ultrasonic pulse output section outputs the ultrasonic pulse.

According to the present invention, the ultrasonic measurement apparatus may further include a pulsed light output section arranged to output pulsed light, wherein the ultrasonic wave is an optoacoustic wave generated by the pulsed light at the measuring target.

According to the ultrasonic measurement apparatus of the present invention, the elapsed time point may be taken within a predetermined range of a time point obtained by adding the focal distance divided by the speed of sound to the time point when the pulsed light output section outputs the pulsed light.

According to the ultrasonic measurement apparatus of the present invention, the lens moving section may be arranged to move the lens closer to the measuring target.

According to the ultrasonic measurement apparatus of the present invention, the lens moving section may be arranged to move the lens away from the measuring target.

According to the ultrasonic measurement apparatus of the present invention, after it is determined that the ultrasonic wave is included in the result of measurement by the ultrasonic measuring section at the elapsed time point, the lens moving section may further move the lens closer to the measuring target.

According to the ultrasonic measurement apparatus of the present invention, after it is determined that the ultrasonic wave is included in the result of measurement by the ultrasonic measuring section at the elapsed time point, the lens moving section may further move the lens away from the measuring target.

The present invention is an ultrasonic measurement method with using an ultrasonic measurement apparatus including a lens arranged to receive an ultrasonic wave output from a measuring target and a lens moving section arranged to move the lens, the method including: measuring the ultrasonic wave received by the lens in relation to time; and determining whether or not the ultrasonic wave is included in a measurement result from the measuring at an elapsed time point when the time required for the ultrasonic wave to travel a focal distance of the lens has elapsed after the ultrasonic wave is output from the measuring target, wherein a lens moving section is arranged to move the lens such that it is determined that the ultrasonic wave is included in the measurement result from the measuring.

The present invention is a non-transitory computer-readable medium including a program of instructions for execution by a computer to perform an ultrasonic measurement process with using an ultrasonic measurement apparatus including a lens arranged to receive an ultrasonic wave output from a measuring target and a lens moving section arranged to move the lens, the ultrasonic measurement process including: measuring the ultrasonic wave received by the lens in relation to time; and determining whether or not the ultrasonic wave is included in a measurement result from the measuring at an elapsed time point when the time required for the ultrasonic wave to travel a focal distance of the lens has elapsed after the ultrasonic wave is output from the measuring target, wherein a lens moving section is arranged to move the lens such that it is determined that the ultrasonic wave is included in the measurement result from the measuring.

### BRIEF DESCRIPTION OF THE DRAWINGS

FIG. 1 is a functional block diagram showing the configuration of an ultrasonic measurement apparatus 1 according to a first embodiment of the present invention;

FIG. 2 is a cross-sectional view of a measuring head 10 according to the first embodiment of the present invention;

FIG. 3 is a functional block diagram showing the configuration of the ultrasonic measurement apparatus 1 according to the second embodiment of the present invention; and

FIG. 4 is a cross-sectional view of a measuring head 10 according to the second embodiment of the present invention.

### DESCRIPTION OF THE PREFERRED EMBODIMENTS

Preferred embodiments of the present invention will hereinafter be described with reference to the accompanying drawings.

### First Embodiment

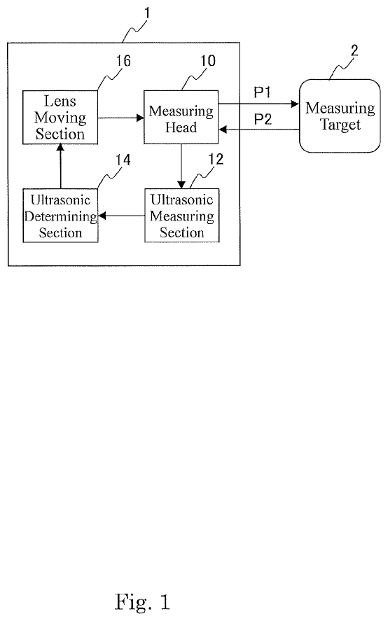

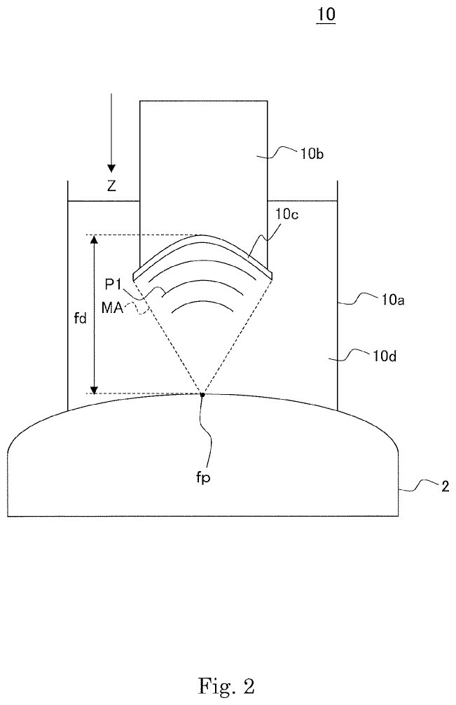

FIG. 1 is a functional block diagram showing the configuration of an ultrasonic measurement apparatus 1 according to a first embodiment of the present invention. FIG. 2 is a cross-sectional view of a measuring head 10 according to the first embodiment of the present invention.

The ultrasonic measurement apparatus 1 according to the first embodiment includes a measuring head (ultrasonic pulse output section) 10, an ultrasonic measuring section 12, an ultrasonic determining section 14, and a lens moving section 16.

The measuring head (ultrasonic pulse output section) 10 is arranged to output an ultrasonic pulse P1. The measuring head 10 is in contact with a measuring target 2. The measuring target 2 is, for example, skin curved in an upward convex manner. The measuring head 10 has a spacer 10a, a sensor 10b, a lens 10c, and water 10d.

The spacer 10a has a thin film (not shown) at the bottom, the thin film curved along the surface of the measuring target 2. The water 10d is contained within the spacer 10a. In FIG. 1, the focal point fp of the lens 10c is on the surface of the measuring target 2 and, in such a case, the tip end of the sensor 10b and the lens 10c are contained within the water 10d.

The lens 10c is arranged to receive an ultrasonic wave P2 output from the measuring target 2 (see FIG. 1). It is noted that the ultrasonic wave P2 is a reflection of the ultrasonic pulse P1 by the measuring target 2. The focal distance of the lens 10c is also represented by fd.

The sensor 10b is an ultrasonic sensor arranged to receive the ultrasonic wave P2, which is received by the lens 10c, convert it into an electrical signal and provide it to the ultrasonic measuring section 12. It is noted that while the sensor 10b and the lens are separate components in the first embodiment, the sensor 10b itself may be curved to serve also as a lens. It is also noted that while the sensor 10b and the lens 10c are in contact with each other in the first embodiment, the sensor 10b may be flat and separated from the lens 10c.

The ultrasonic measuring section 12 is arranged to measure the ultrasonic wave P2 received by the lens 10c in relation to time.

The ultrasonic determining section 14 is arranged to determine whether or not the ultrasonic wave P2 is included in a result of measurement by the ultrasonic measuring section 12 at an elapsed time point when the time required for the ultrasonic wave P2 to travel the focal distance fd of the lens 10c (fd/Vs, where Vs represents the speed of sound) has elapsed after the ultrasonic wave P2 is output (reflected) from the measuring target 2. As an example, whether or not the ultrasonic wave P2 is included may be determined based on whether or not the power of the result of measurement (or a component thereof at a specific frequency) exceeds a predetermined threshold value.

Note here that the elapsed time point is taken within a predetermined range (+/−Δt) of a time point obtained by adding twice the focal distance fd divided by the speed of sound Vs to the time point t0 when the ultrasonic pulse output section (measuring head 10) outputs the ultrasonic pulse. That is, the elapsed time point is taken between t0+2fd/Vs−Δt and t0+2fd/Vs+Δt.

If the focal point fp of the lens 10c is on the surface of the measuring target 2, the ultrasonic pulse P1 reaches the measuring target 2 and the ultrasonic wave P2 is output (reflected) from the measuring target 2 at a time point (t0+fd/Vs) obtained by adding the focal distance fd divided by the speed of sound Vs to the time point t0 when the ultrasonic pulse output section (measuring head 10) outputs the ultrasonic pulse. The ultrasonic wave P2 reaches the lens 10c at a time point (t0+2fd/Vs) obtained by adding the focal distance fd divided by the speed of sound Vs to the time point (t0+fd/Vs) when the ultrasonic wave P2 is output (reflected) from the measuring target 2. Note here that in view of, for example, the variation in the speed of sound Vs due to, for example, the temperature of the water 10d, the focal point fp of the lens 10c is considered to be on the surface of the measuring target 2 if within a predetermined range (+/−Δt) of t0+2fd/Vs.

The lens moving section 16 is arranged to move the lens 10c such that it is determined that the ultrasonic wave P2 is included in the result of measurement by the ultrasonic measuring section 12. This allows the focal point fp of the lens 10c to be on the surface of the measuring target 2.

For example, the lens moving section 16 is arranged to move the lens 10c sufficiently away from the measuring target 2 (the focal point fp is at a position higher than that of the surface of the measuring target 2) and then move the lens 10c in the Z direction (height direction) closer to the measuring target 2. Alternatively, the lens moving section 16 is arranged to move the lens 10c sufficiently closer to the measuring target 2 (the focal point fp is at a position lower than that of the surface of the measuring target 2) and then move the lens 10c in the Z direction (height direction) away from the measuring target 2.

Next will be described an operation according to the first embodiment.

First, the lens 10c of the measuring head 10 should be sufficiently far away from the measuring target 2. At least the focal point fp should be at a position higher than that of the surface of the measuring target 2.

Next, an ultrasonic pulse P1 is emitted from the lens 10c of the ultrasonic pulse output section (measuring head 10) toward the measuring target 2 (at a time point t0). The ultrasonic pulse P1 is reflected by the surface of the measuring target 2 (to be an ultrasonic wave P2) toward the lens 10c. The ultrasonic wave P2 reaches the lens 10c at a time point later than t0+2fd/Vs.

The ultrasonic wave P2 received by the lens 10c is converted through the sensor 10b into an electrical signal and provided to the ultrasonic measuring section 12. A result of measurement by the ultrasonic measuring section 12 is provided to the ultrasonic determining section 14 and it is determined that the ultrasonic wave P2 is not included in the result of measurement by the ultrasonic measuring section 12 at the elapsed time point (t0+2fd/Vs).

Based on the determination, the lens moving section 16 moves the lens 10c in the Z direction (height direction) closer to the measuring target 2.

In due course, the focal point fp is then placed on the surface of the measuring target 2 (see FIG. 1).

An ultrasonic pulse P1 is emitted from the lens 10c of the ultrasonic pulse output section (measuring head 10) toward the measuring target 2 (at a time point t0). The ultrasonic pulse P1 is reflected by the surface of the measuring target 2 (to be an ultrasonic wave P2) toward the lens 10c. The ultrasonic wave P2 reaches the lens 10c at a time point between t0+2fd/Vs−Δt and t0+2fd/Vs+Δt even in view of, for example, the variation in the speed of sound Vs.

The ultrasonic wave P2 received by the lens 10c is converted through the sensor 10b into an electrical signal and provided to the ultrasonic measuring section 12. A result of measurement by the ultrasonic measuring section 12 is provided to the ultrasonic determining section 14 and it is determined that the ultrasonic wave P2 is included in the result of measurement by the ultrasonic measuring section 12 at the elapsed time point (between t0+2fd/Vs−Δt and t0+2fd/Vs+Δt).

Based on the determination, the lens 10c stops with the focal point fp kept on the surface of the measuring target 2.

It is noted that also in the case where the lens 10c of the measuring head 10 is first moved sufficiently closer to the measuring target 2 (at least the focal point fp is at a position lower than that of the surface of the measuring target 2) and then moved by the lens moving section 16 in the Z direction (height direction) away from the measuring target 2, the lens 10c likewise stops with the focal point fp kept on the surface of the measuring target 2.

In accordance with the first embodiment, the focal point fp of the lens 10c can be placed on the surface of the measuring target 2 automatically.

It is noted that various variations to the first embodiment are also possible as will be described hereinafter.

### First Variation

The focal point fp is on the surface of the measuring target 2 and it is determined by the ultrasonic determining section 14 that the ultrasonic wave P2 is included in the result of measurement by the ultrasonic measuring section 12 at the elapsed time point, up to which the operation is the same as in the first embodiment.

In the first variation, the lens moving section 16 then further moves the lens 10c closer to the measuring target 2.

In accordance with the first variation, the focal point fp can be placed on the surface of the measuring target 2 and then further placed in the measuring target 2 (e.g. in the hypodermis (particularly in the subcutaneous fat)).

The skin includes epidermis, dermis, and hypodermis. Ultrasound is significantly attenuated within the hypodermis (particularly within the subcutaneous fat). It is therefore preferred that the focal point fp be placed in the deep dermis or the hypodermis in order to ultrasonically measure the hypodermis. It is hence preferable to place the focal point fp in the measuring target 2 (e.g. in the hypodermis (particularly in the subcutaneous fat)), as described above, to measure the hypodermis.

### Second Variation

The focal point fp is on the surface of the measuring target 2 and it is determined by the ultrasonic determining section 14 that the ultrasonic wave P2 is included in the result of measurement by the ultrasonic measuring section 12 at the elapsed time point, up to which the operation is the same as in the first embodiment.

In the second variation, the lens moving section 16 then moves the lens 10c away from the measuring target 2.

In accordance with the second variation, the entire measuring target 2 is positioned lower than the focal point fp. While the measuring target 2 would become difficult for image processing if having portions higher and lower than the focal point fp, the entire measuring target 2 is positioned lower than the focal point fp, which can facilitate image processing for the measuring target 2.

### Second Embodiment

An ultrasonic measurement apparatus 1 according to a second embodiment is arranged to receive an optoacoustic wave AW from the measuring target 2, which differs from the first embodiment in which an ultrasonic wave P2 is received from the measuring target 2.

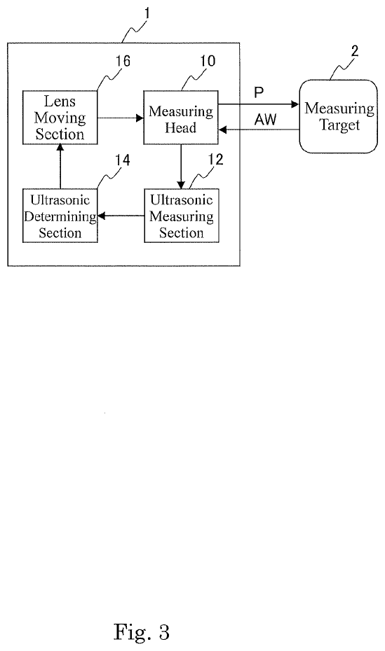

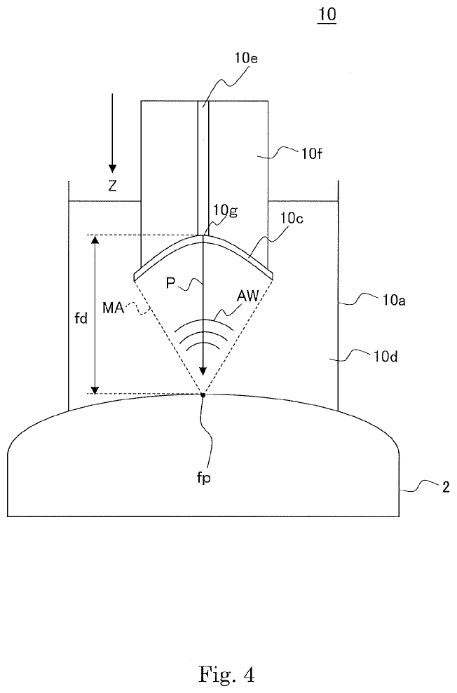

FIG. 3 is a functional block diagram showing the configuration of the ultrasonic measurement apparatus 1 according to the second embodiment of the present invention. FIG. 4 is a cross-sectional view of a measuring head 10 according to the second embodiment of the present invention. The components identical to those in the first embodiment will hereinafter be designated by the same reference numerals to omit the description thereof.

The ultrasonic measurement apparatus 1 according to the second embodiment includes a measuring head 10, an ultrasonic measuring section 12, an ultrasonic determining section 14, and a lens moving section 16.

The measuring head 10 is arranged to output pulsed light P. The measuring head 10 is in contact with a measuring target 2. The measuring target 2 is identical to that in the first embodiment and will not be described. The measuring head 10 has a spacer 10a, a lens 10c, water 10d, an optical fiber (pulsed light output section) 10e, an optical fiber retaining section 10f, and an output end 10g.

The spacer 10a and the water 10d are identical to those in the first embodiment and will not be described.

The optical fiber (pulsed light output section) 10e is arranged to output pulsed light P from the output end 10g. It is noted that the pulsed light P is output in the Z direction. The measuring target 2 is arranged to generate an optoacoustic wave AW upon receiving the pulsed light P. The optical fiber retaining portion 10f is arranged around the optical fiber 10e to retain the optical fiber 10e.

In FIG. 4, the focal point fp of the lens 10c is on the surface of the measuring target 2 and, in such a case, the tip end of the optical fiber retaining portion 10f and the lens 10c are contained within the water 10d.

The lens 10c is arranged to receive an ultrasonic wave (optoacoustic wave AW) output from the measuring target 2 (see FIGS. 3 and 4). It is noted that the optoacoustic wave AW is generated from the pulsed light P at the measuring target 2. The focal distance of the lens 10c is also represented by fd, as in the first embodiment.

The sensor 10b is identical to that in the first embodiment except for receiving the ultrasonic wave (optoacoustic wave AW), which is received by the lens 10c, and will not be described.

The ultrasonic measuring section 12 is arranged to measure the ultrasonic wave (optoacoustic wave AW) received by the lens 10c in relation to time.

The ultrasonic determining section 14 is arranged to determine whether or not the ultrasonic wave (optoacoustic wave AW) is included in a result of measurement by the ultrasonic measuring section 12 at an elapsed time point when the time required for the ultrasonic wave to travel the focal distance fd of the lens 10c (fd/Vs) has elapsed after the ultrasonic wave is output from the measuring target 2. As an example, whether or not the ultrasonic wave (optoacoustic wave AW) is included may be determined based on whether or not the power of the result of measurement (or a component thereof at a specific frequency) exceeds a predetermined threshold value.

Note here that the elapsed time point is taken within a predetermined range (+/−Δt) of a time point obtained by adding the focal distance fd divided by the speed of sound Vs to the time point t0 when the optical fiber (pulsed light output section) 10e outputs the pulsed light P. That is, the elapsed time point is taken between t0+fd/Vs−Δt and t0+fd/Vs+Δt.

If the focal point fp of the lens 10c is on the surface of the measuring target 2, the pulsed light P reaches the measuring target 2 and the ultrasonic wave (optoacoustic wave AW) is output from the measuring target 2 at approximately the same time as the time point t0 when the optical fiber (pulsed light output section) 10e outputs the pulsed light P. The ultrasonic wave (optoacoustic wave AW) reaches the lens 10c at a time point (t0+fd/Vs) obtained by adding the focal distance fd divided by the speed of sound Vs to the time point (t0) when the ultrasonic wave (optoacoustic wave AW) is output from the measuring target 2. Note here that in view of, for example, the variation in the speed of sound Vs due to, for example, the temperature of the water 10d, the focal point fp of the lens 10c is considered to be on the surface of the measuring target 2 if within a predetermined range (+1−Δt) of t0+fd/Vs.

The lens moving section 16 is arranged to move the lens 10c such that it is determined that the ultrasonic wave (optoacoustic wave AW) is included in the result of measurement by the ultrasonic measuring section 12. This allows the focal point fp of the lens 10c to be on the surface of the measuring target 2.

For example, the lens moving section 16 is arranged to move the lens 10c sufficiently away from the measuring target 2 (the focal point fp is at a position higher than that of the surface of the measuring target 2) and then move the lens 10c in the Z direction (height direction) closer to the measuring target 2. Alternatively, the lens moving section 16 is arranged to move the lens 10c sufficiently closer to the measuring target 2 (the focal point fp is at a position lower than that of the surface of the measuring target 2) and then move the lens 10c in the Z direction (height direction) away from the measuring target 2.

Next will be described an operation according to the second embodiment.

First, the lens 10c of the measuring head 10 should be sufficiently far away from the measuring target 2. At least the focal point fp should be at a position higher than that of the surface of the measuring target 2.

Next, pulsed light P is emitted from the optical fiber (pulsed light output section) 10e toward the measuring target 2 (at a time point t0). When the pulsed light P reaches the surface of the measuring target 2, an ultrasonic wave (optoacoustic wave AW) is generated toward the lens 10c. The ultrasonic wave (optoacoustic wave AW) reaches the lens 10c at a time point later than t0+fd/Vs.

The ultrasonic wave (optoacoustic wave AW) received by the lens 10c is converted through the sensor 10b into an electrical signal and provided to the ultrasonic measuring section 12. A result of measurement by the ultrasonic measuring section 12 is provided to the ultrasonic determining section 14 and it is determined that the ultrasonic wave (optoacoustic wave AW) is not included in the result of measurement by the ultrasonic measuring section 12 at the elapsed time point (t0+fd/Vs).

Based on the determination, the lens moving section 16 moves the lens 10c in the Z direction (height direction) closer to the measuring target 2.

In due course, the focal point fp is then placed on the surface of the measuring target 2 (see FIG. 1).

Pulsed light P is emitted from the optical fiber (pulsed light output section) 10e toward the measuring target 2 (at a time point t0). When the pulsed light P reaches the surface of the measuring target 2, an ultrasonic wave (optoacoustic wave AW) is generated toward the lens 10c. The ultrasonic wave (optoacoustic wave AW) reaches the lens 10c at a time point between t0+fd/Vs−Δt and t0+fd/Vs+Δt even in view of, for example, the variation in the speed of sound Vs.

The ultrasonic wave (optoacoustic wave AW) received by the lens 10c is converted through the sensor 10b into an electrical signal and provided to the ultrasonic measuring section 12. A result of measurement by the ultrasonic measuring section 12 is provided to the ultrasonic determining section 14 and it is determined that the ultrasonic wave (optoacoustic wave AW) is included in the result of measurement by the ultrasonic measuring section 12 at the elapsed time point (between t0+fd/Vs−Δt and t0+fd/Vs+Δt).

Based on the determination, the lens 10c stops with the focal point fp kept on the surface of the measuring target 2.

It is noted that also in the case where the lens 10c of the measuring head 10 is first moved sufficiently closer to the measuring target 2 (at least the focal point fp is at a position lower than that of the surface of the measuring target 2) and then moved by the lens moving section 16 in the Z direction (height direction) away from the measuring target 2, the lens 10c likewise stops with the focal point fp kept on the surface of the measuring target 2.

In accordance with the second embodiment, automatic focusing of the lens 10c can also be achieved in such a case where an optoacoustic wave AW is received from the measuring target 2.

It is noted that also in the second embodiment, after the focal point fp is placed on the surface of the measuring target 2 and it is determined by the ultrasonic determining section 14 that the ultrasonic wave (optoacoustic wave AW) is included in the result of measurement by the ultrasonic measuring section 12 at the elapsed time point, the lens moving section 16 may then further move the lens 10c closer to or away from the measuring target 2, as is the case in the first and second variations of the first embodiment.

Incidentally, the above-described embodiments may be achieved as follows. A computer including a CPU, a hard disk, and a medium (USB memory, CD-ROM, or the like) reading device is caused to read a medium with a program recorded thereon that achieves the above-described components (e.g. ultrasonic measuring section 12 and ultrasonic determining section 14) and install the program in the hard disk. The above-described features can also be achieved in this manner.

### DESCRIPTION OF REFERENCE NUMERAL

1 Ultrasonic Measurement Apparatus
10 Measuring Head (Ultrasonic Pulse Output Section)
10a Spacer
10b Sensor
10c Lens
10d Water
10e Optical Fiber (Pulsed Light Output Section)
10f Optical Fiber Retaining Section
10g Output End
12 Ultrasonic Measuring Section
14 Ultrasonic Determining Section
16 Lens Moving Section
P1 Ultrasonic Pulse
P2 Ultrasonic Wave
P Pulsed Light
AW Optoacoustic Wave (Ultrasonic Wave)
fp Focal Point
fd Focal Distance
Vs Speed of Sound

What is claimed is:

1. An ultrasonic measurement apparatus, comprising:
a lens arranged to receive an ultrasonic wave output from a measuring target;
an ultrasonic measuring section arranged to measure the ultrasonic wave received by the lens in relation to time;
an ultrasonic determining section arranged to determine whether or not the ultrasonic wave is included in a result of measurement by the ultrasonic measuring section at an elapsed time point when the time required for the ultrasonic wave to travel a focal distance of the lens has elapsed after the ultrasonic wave is output from the measuring target; and
a lens moving section arranged to move the lens such that it is determined that the ultrasonic wave is included in the result of measurement by the ultrasonic measuring section.

2. The ultrasonic measurement apparatus according to claim 1, further comprising, an ultrasonic pulse output section arranged to output an ultrasonic pulse, wherein
the ultrasonic wave is a reflection of the ultrasonic pulse by the measuring target.

3. The ultrasonic measurement apparatus according to claim 2, wherein
the elapsed time point is taken within a predetermined range of a time point obtained by adding twice the focal distance divided by the speed of sound to the time point when the ultrasonic pulse output section outputs the ultrasonic pulse.

4. The ultrasonic measurement apparatus according to claim 1, further comprising, a pulsed light output section arranged to output pulsed light, wherein
the ultrasonic wave is an optoacoustic wave generated by the pulsed light at the measuring target.

5. The ultrasonic measurement apparatus according to claim 4, wherein
the elapsed time point is taken within a predetermined range of a time point obtained by adding the focal distance divided by the speed of sound to the time point when the pulsed light output section outputs the pulsed light.

6. The ultrasonic measurement apparatus according to claim 1, wherein
the lens moving section is arranged to move the lens closer to the measuring target.

7. The ultrasonic measurement apparatus according to claim 1, wherein
the lens moving section is arranged to move the lens away from the measuring target.

8. The ultrasonic measurement apparatus according to claim 1, wherein
after it is determined that the ultrasonic wave is included in the result of measurement by the ultrasonic measuring section at the elapsed time point, the lens moving section further moves the lens closer to the measuring target.

9. The ultrasonic measurement apparatus according to claim 1, wherein
after it is determined that the ultrasonic wave is included in the result of measurement by the ultrasonic measuring section at the elapsed time point, the lens moving section further moves the lens away from the measuring target.

10. An ultrasonic measurement method with using an ultrasonic measurement apparatus including a lens arranged to receive an ultrasonic wave output from a measuring target and a lens moving section arranged to move the lens, said method comprising:
measuring the ultrasonic wave received by the lens in relation to time; and
determining whether or not the ultrasonic wave is included in a measurement result from the measuring at an elapsed time point when the time required for the ultrasonic wave to travel a focal distance of the lens has elapsed after the ultrasonic wave is output from the measuring target, wherein
a lens moving section is arranged to move the lens such that it is determined that the ultrasonic wave is included in the measurement result from the measuring.

11. A non-transitory computer-readable medium including a program of instructions for execution by a computer to perform an ultrasonic measurement process with using an ultrasonic measurement apparatus including a lens arranged to receive an ultrasonic wave output from a measuring target and a lens moving section arranged to move the lens, said ultrasonic measurement process comprising:
measuring the ultrasonic wave received by the lens in relation to time; and
determining whether or not the ultrasonic wave is included in a measurement result from the measuring at an elapsed time point when the time required for the ultrasonic wave to travel a focal distance of the lens has elapsed after the ultrasonic wave is output from the measuring target, wherein
a lens moving section is arranged to move the lens such that it is determined that the ultrasonic wave is included in the measurement result from the measuring.
